(19) United States
(12) Patent Application Publication
(10) Pub. No.: US 2016/0148224 A1
(43) Pub. Date: May 26, 2016

(54) Prediction of Consumer Spending

(71) Applicant: MasterCard Asia Pacific Pte. Ltd., Singapore (SG)

(72) Inventor: Sukanyya Misra, Gurgaon (IN)

(21) Appl. No.: 14/552,271

(22) Filed: Nov. 24, 2014

(51) Int. Cl. G06Q 30/02

(52) U.S. Cl. CPC G06Q 30/0202

(57) ABSTRACT

A computer-implemented method for prediction of consumer spending in a specific merchant category, the method comprising: identifying a correlation between the specific merchant category and two or more merchant categories, the two or more merchant categories different from the specific merchant category; selecting one or more merchant categories based on a degree of the correlation; fitting data of the selected one or more merchant categories to a time-series model; and predicting consumer spending in the specific merchant category using the output of the time-series model.

### TECHNICAL FIELD OF INVENTION

The following discloses a computer-implemented method for prediction of consumer spending.

### BACKGROUND

Competition and Government regulations may require financial companies to continuously improve their overall method of utilizing their big data (i.e. extremely large and complex datasets) to accurately monitor and forecast their business matrices. While a country's or bank's overall transaction or spend history can be tracked over time, it has become increasingly important to also provide accurate forecasts of overall spend in an industry and/or in a specific geography.

Currently, the common practice for forecasting spending or transaction behaviour is to fit a linear regression model on aggregated transaction history which involves transforming time-series variables to static variables. The simplistic algorithm of linear regression has been widely adopted by the financial industry due to common knowledge of techniques, software and skills available. However, linear regression models work on the assumption that all variables are independent of each other and follow no autocorrelation (i.e. no time-series behaviour), which in reality is not true.

An exemplary linear regression which shows the static relationship with a predicted variable and the independent predictor variables may be in the form of:

Yᵢ=c+βᵢXᵢ+ . . . +eᵢ, i=1,2,3, . . . eᵢ˜N(0,1)

where Y is the predicted value at a point of time and X₁, X₂ . . . are independent static variables; c is a constant; βᵢ are coefficients and e is the error term assuming a Normal (0, 1) distribution.

The current practice of fitting a linear regression model on aggregated transaction history is at a cost of losing the granular and time-series data, thereby, compromising the predictive power of the models. Moreover, a typical linear regression predictive model can take anywhere from four to six weeks to develop and another eight to twelve weeks to implement.

A need therefore exists to provide method(s) for prediction of consumer spending that seeks to address at least the above-mentioned problems.

### SUMMARY

According to a first aspect of the invention, there is provided a computer-implemented method for prediction of consumer spending in a specific merchant category, the method comprising: identifying a correlation between the specific merchant category and two or more merchant categories, the two or more merchant categories different from the specific merchant category; selecting one or more merchant categories based on a degree of the correlation; fitting data of the selected one or more merchant categories to a time-series model; and predicting consumer spending in the specific merchant category using the output of the time-series model.

The method may comprise using principal component analysis (PCA) to identify the correlation between the two or more merchant categories with the specific merchant category.

The method may further comprise selecting two or more principal components; and calculating an eigenvalue for each of the selected principal components to identify the correlation between the two or more merchant categories. The selected principal components may account for a user determined degree of variance, upon which the correlation is based.

The step of predicting consumer spending in the specific merchant category using the output of the time-series model may comprise comparing the output associated with the specific merchant category against the output associated with the selected one or more merchant categories to predict consumer spending in the specific merchant category.

The time-series model may be either an autoregressive (AR), autoregressive moving average (ARMA) or autoregressive integrated moving average (ARIMA) model. The data of each of the selected merchant categories may comprise consumer spending in the corresponding selected merchant category. The data of each of the selected merchant categories may be obtained based on historical transaction data. The historical transaction data may comprise one or more of: merchant identity, transaction amount, date of transaction, merchant category code (MCC), industry code, and industry description.

According to a second aspect of the invention, there is provided an apparatus comprising: at least one processor; and at least one memory including computer program code, the at least one memory and the computer program code configured to, with the at least one processor, cause the apparatus at least to: identify a correlation between the specific merchant category and two or more merchant categories, the two or more merchant categories different from the specific merchant category; select one or more merchant categories (which are independent variables) based on a degree of the correlation; fit data of the selected one or more merchant categories to a time-series model; and predict consumer spending in the specific merchant category using the output of the time-series model. Principal component analysis (PCA) may be used to convert the correlated variables into orthogonal (uncorrelated) variables.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a flowchart depicting steps of a method for prediction of consumer spending, according to an exemplary implementation of the invention;

Table 1 shows raw data of consumer spending in five merchant categories over thirty-six months;

Table 2 shows the correlation matrix between the spends of four industry categories, the corresponding four principal components, their eigenvalues and the eigenvectors;

Table 3 shows the forecasted spending for the various months;

Table 4 shows the performance results of the model according to an exemplary implementation of the invention; and

FIG. 2 shows an exemplary computing device capable of executing the method for prediction of consumer spending according to various the implementations described herein.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods disclosed herein. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM, GPRS, 3G or 4G mobile telephone systems. The computer program when loaded and executed on such a general-purpose computer effectively results in an apparatus that implements the steps of the preferred method.

The invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

Embodiments of the invention seek to predict consumer spending in a specific industry/merchant category over a specific period of time. In particular, embodiments of the invention seek to enhance the accuracy of predicted spend volume and consumer spend behaviour in an industry/merchant category.

Embodiments of the invention also seek to leverage big data (i.e. extremely large and complex datasets) in granular form, retain the autocorrelation relationship across industry/merchant categories and predict highly accurate spend behaviour.

In an example implementation to predict consumer spending, there is provided a time-series modeling method for spend prediction that is based on transaction data using principal components of original variables. The method may be implemented using a general-purpose computer, as described below.

A method of predicting spending, according to an implementation of the invention, comprises the following steps.

Step 1: Obtain Transaction Data History

Transaction data history over a pre-determined period of time (e.g. 5 years) is obtained. Transaction data history typically comprises anonymized and aggregated spend information by customer/account at a specific merchant site at a specific time and location.

In an implementation, a transaction processing system is configured to capture all transactions in a transaction network. It is expected that millions of granular transaction data can be captured. The granular transaction data can be uploaded to a data warehouse on a regular basis (e.g. daily, weekly, monthly). Various algorithms/rules can be applied to anonymize the transaction data so that no personally identifiable numbers are available to the users of the data.

For example, the following types of transaction data can be captured:

Transaction Level Information:
Transaction ID
Account ID (anonymized)
Merchant ID
Transaction Amount
Transaction Local Currency Amount
Date of Transaction
Time of Transaction
Type of Transaction
Date of Processing
Cardholder Present Code
Merchant Category Code (MCC)

Account Information:
Account ID (anonymized)
Card Group Code
Card Product Code
Card Product Description
Card Issuer Country
Card Issuer ID
Card Issuer Name
Aggregate Card Issuer ID
Aggregate Card Issuer Name

Merchant Information:
Merchant ID
Merchant Name
MCC/Industry Code
Industry Description
Merchant Country
Merchant Address
Merchant Postal Code
Aggregate Merchant ID
Aggregate Merchant Name
Merchant Acquirer Country
Merchant Acquirer ID

Issuer Information:
Issuer ID
Issuer Name
Aggregate Issuer ID
Issuer Country

The obtained transaction data history often comprises extremely large and complex datasets (i.e. “big data”). In general, transaction data for a specific geography and industry follow time series behaviour and are highly autocorrelated (e.g. today's spend is related to spend from last day or week or month). A correlation between two or more groups of information is then determined. In this context, “correlation” means that changes in one group (e.g. increased expenditure in a particular category of products such as apparel) leads to changes in another group (e.g. increased expenditure in another category of products such as airline tickets). The change can be directly proportional where increased expenditure in one category leads to increased expenditure in another category; or inversely proportional where increased expenditure in one category leads to decreased expenditure in another category. For instance, a customer's grocery spending on a weekday is correlated with his grocery spending over the past weekend and such autocorrelation can be observed over a few months or seasons. Similarly, spend in one industry category can be correlated with spend in a few other industries. For instance, spend in retail apparel may have a strong correlation with spend on airline tickets.

For example, MasterCard™ collects global transaction records of customers at the rate of about 840 transactions every second. Such transactions and spend volumes are being recorded across several destinations, industry categories and merchant types through various electronic instruments like debit or credit cards, mobile or e-commerce sites. MasterCard™'s big data captures billions of anonymous transaction data which is highly correlated across spend categories like industry, customer demographics and location while the spend data is also autoregressive.

Step 2: Principal Component Analysis

Principal component analysis (PCA) is a statistical procedure that uses orthogonal transformation to convert a set of observations of possibly correlated variables into a set of values of linearly uncorrelated variables called principal components (PCs). The number of principal components is less than or equal to the number of original variables. The transformation is defined in such a way that the first principal component has the largest possible variance, and each succeeding principal component in turn has the highest variance possible under the constraint that it be orthogonal to (i.e. uncorrelated with) the preceding components.

The principal component variables are a linear combination of correlated transaction variables/spend variables even though the principal components are independent of each other. In an implementation, the correlated transaction variables/spend variables are transformed into corresponding independent principal components (which are linear combinations of a number of correlated variables, i.e. PCᵢ=aᵢXᵢ+eᵢ where i=1, 2, 3, . . . , Xᵢ is a variable and eᵢ is the error term).

PCA is one way of identifying the subset of variables in a multivariate setting that are correlated. PCA transforms the original transaction variables in the vector X into a new set of variables in Z such that the components in Z are independent of each other. Hence, Z=U′(X−⁻X), where U is orthonormal i.e. U′U=1 and U is such that U′SU=L, where, S=Cov̂(X) and L is a diagonal matrix and is the covariance matrix of the principal components Z. The diagonal elements of L are called characteristic roots or eigenvalues and the columns of U are called the characteristic vectors or eigenvectors of S. The calculated eigenvalues of each principal component indicates the variance contributed by the principal component. A greater eigenvalue indicates a larger contribution of variance.

One of the uses of PCA is its ability to transform correlated variables into uncorrelated variables and to adequately represent a multivariate situation in a much reduced dimension. The first few principal components (zᵢ's) may account for most of the variability and the remaining principal components may be small and of the same order of magnitude. That is, the first few principal components have the greatest eigenvalues.

Accordingly, it is possible to use only those variables or principal components in the modeling which account for most of the variability. That is, the principal components that account for most of the variability are selected/retained for modeling and the remaining principal components are discarded. For example, the principal components that account for a predetermined level of variability (e.g. 98%) are selected. The principal components that contribute to the remaining 2% are discarded. Although PCA transforms correlated variables into uncorrelated variables, it does not get rid of the autocorrelation in the variables.

Step 3: Principal Component Based Multivariate Time-Series AR/ARMA Model Development

A time-series model can be fitted on the selected principal components based on statistical modeling techniques. The model's outcome can be spend trends over time. Modeling the Principal Components using time-series techniques utilize granular transaction data and advantageously capture the autoregressive or seasonality of relationship.

In an example implementation, time-series autocorrelated models like autoregressive (AR), autoregressive moving average (ARMA) or autoregressive integrated moving average (ARIMA) are fitted on the principal components. The original time-series distribution of variables is retained by their principal components, and hence fitting the time-series AR, ARMA or ARIMA model is appropriate. The forecasted spend values for a specific industry category over a period of time (e.g. six to twelve months) is expected to provide an accurate estimation of actual spend behaviour of customers.

The first order autoregressive (AR) time series model below shows the algorithm where current and past values of the variables predict its future values based on an autoregressive relationship:

xₜ=μ+φ(xₜ₋₁−μ)+aₜ, t=1,2,3,4 . . . and aₜ˜N(0,σ²)
where xₜ is the spend at time t, μ is a constant, φ is the coefficient and aₜ is the error at time t.

For multivariate autoregressive models, an exemplary implementation starts with four correlated variables involving X₁ₜ, X₂ₜ, X₃ₜ and X₄ₜ following four-variate AR(1) series:

Uₜ=Φ_{Ut}Uₜ₋₁+εₜ,

where Uₜ=(X₁ₜ, X₂ₜ, X₃ₜ, X₄ₜ)′

Uₜ₋₁=(X₁ₜ₋₁, X₂ₜ₋₁, X₃ₜ₋₁, X₄ₜ₋₁)′ where Xᵢₜ's (i=1,2,3,4) may be highly correlated;

Φ_{Ut}=AR(1) parameter matrix for vector Uₜ

and εₜ=(ε₁ₜ, ε₂ₜ, ε₃ₜ, ε₄ₜ)′ and εₜ˜N(0, Σ_{ε}) being the residual vector following normal distribution with mean 0 and variance matrix Σ_{ε}. Since the Xᵢₜ's are correlated, principal component analysis can transform them to uncorrelated variables while reducing the dimensions.

The Principal Component Scores are calculated using the following equation: Zₜ=V′.Uₜ

where Zₜ=(PCS₁ PCS₂ PCS₃ PCS₄) and V is the eigenvector. The higher principal components (e.g., PCS₁ and/or PCS₂) are chosen in the model as they explain majority of the variability, while the lower principal components (e.g. PCS₄) are helpful in outlier detection. Here, the Principal Component Scores are equivalent to the eigenvalue.

Hence, a bivariate AR(1) can be fitted on PCS₁ and PCS₄ as follows:

Uₜ=Φ_{zt}Zₜ₋₁*+ε_{Zt},
where Uₜ=(U₁ₜ, U₂ₜ)′ and may represent transaction values for a specific industry and merchant category by location
Zₜ₋₁*=(PCS1ₜ₋₁, PCS4ₜ₋₁)′ represent the principal component scores of the other industry/merchant category transaction related variables
ε_{Zt}=(ε_{Z1t} ε_{Z2t})′ is the residual vector should represent white noise and Φ_{zt} is the AR(1) coefficient parameter matrix that can be estimated from the model equation.

Time-series modeling software such as MATLAB or SAS may be used to build AR/ARMA models on principal components of transaction variables. A general-purpose computer (as described below) may be used to run the time-series modeling software.

Embodiments of the invention provide a modeling technique that is scalable as it is applicable across geographies and industry/merchant categories. Scoring models of various purchase profiles can also be built leveraging this modeling technique to predict propensities to spend in various categories or profiles.

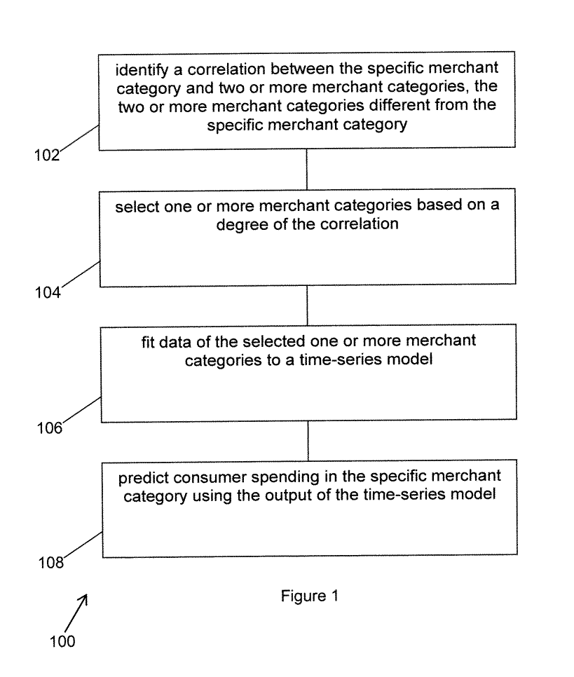

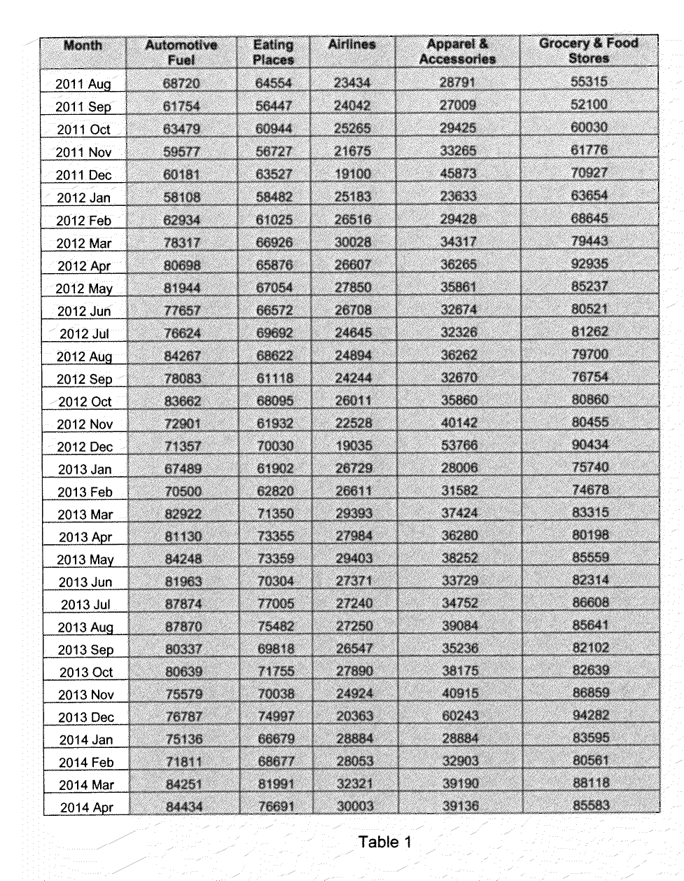

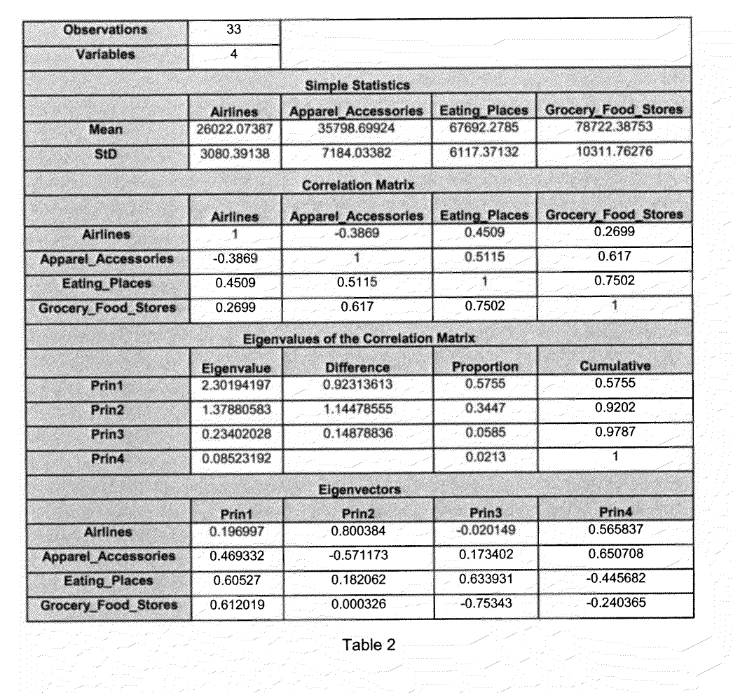

FIG. 1 is a flowchart, designated generally as reference numeral 100, illustrating a method for prediction of consumer spending in a specific merchant category, according to an exemplary implementation of the invention. Step 102 involves identifying a correlation between the specific merchant category and two or more merchant categories. The two or more merchant categories are different from the specific merchant category. Here, the specific merchant category is the independent variable and the two or more merchant categories are dependent variables.

Principal component analysis (PCA) may be used to identify the correlation between the two or more merchant categories with the specific merchant category. PCA may involve selecting two or more principal components and calculating an eigenvalue for each of the selected principal components to identify the correlation between the two or more merchant categories. In particular, the values of the selected two or more merchant values are converted to their principal components (or eigen vectors), which are uncorrelated variables. The selected principal components may account for a pre-determined amount of variability. For example, the principal components that account for most of the variability (e.g. 98%) may be selected. The remaining principal components that account for 2% of the variability are discarded.

Step 104 involves selecting one or more merchant categories based on a degree of the correlation identified in step 102. The one or more merchant categories that are selected are different from the specific merchant category.

Step 106 involves fitting data of the selected one or more merchant categories to a time-series model. The time-series model may be an autoregressive (AR), autoregressive moving average (ARMA) or autoregressive integrated moving average (ARIMA) model. In an implementation, fitting data of the selected one or more merchant categories to a time-series model further may comprise fitting the data against the principal components of the other selected merchant categories.

Step 108 involves predicting consumer spending in the specific merchant category using the output of the time-series model.

In this exemplary implementation, the data of each of the merchant categories may comprise consumer spending in the corresponding merchant category. The data of each of the merchant categories may be obtained based on historical transaction data such as: merchant identity, transaction amount, date of transaction, merchant category code (MCC), industry code, and industry description.

Example Application and Performance Evaluation

The following provides an example application of an implementation of the invention on a data set and the performance results of a model according to the implementation. In this example, consumer spending in the merchant category “automotive fuel” is to be predicted based on values obtained in four related merchant categories—“eating places”, “airlines”, “apparel/accessories” and “grocery/food stores”.

Firstly, historical transaction data over thirty-three months (August 2011 to April 2014) is obtained. Four transaction variables (i.e. consumer spending in four merchant categories—eating places, airlines, apparel/accessories and grocery/food stores) are chosen based on the most common transactions in retail and travel categories. The four spend categories—eating places, airlines, apparel/accessories and grocery/food stores were chosen based on an initial hypothesis that these categories may be highly correlated with spends in automotive fuel. The data/values of the four transaction variables are obtained based on the historical transaction data. The process of obtaining the transaction data is known in the art and is not the focus of the invention and therefore will not be further elaborated. In this example, the values of the four transaction variables may be derived from one or more of the following types of historical transaction data: merchant ID, transaction amount, date of transaction, merchant category code (MCC), industry code, and industry description.

Table 1 shows the values of the four transaction variables over thirty-three months (August 2011 to April 2014). The values of the merchant category “automotive fuel” over the same period of time are also shown in Table 1 for analysis of the prediction results.

With reference to Table 2, there are thirty-three observations (i.e. spending from August 2011 to April 2014) and four transaction variables (i.e. consumer spending in eating places, airlines, apparel/accessories and grocery/food stores). Table 2 also shows the correlation matrix between the four variables, the eigenvalues of the correlation matrix, and the eigenvectors.

The first principal component Prin1 has the largest possible variance (i.e. greatest eigenvalue of 2.30194197), followed by the second principal component Prin2 (second greatest eigenvalue of 1.37880583), followed by the third principal component Prin3 (third greatest eigenvalue of 0.23402028), and finally the fourth principal component Prin4 has the smallest possible variance (i.e. smallest eigenvalue of 0.08523192).

The first few principal components may account for most of the variability and the remaining principal components may be small and of the same order of magnitude. Accordingly, it is possible to use only those variables or principal components in the modeling which account for most of the variability. In this case, the first three principal components (i.e. Prin1, Prin2, Prin3) account for 98% of the variability. This is because, as shown in Table 2, the total “proportion” contributed by Prin1, Prin2, Prin3 is about 0.98 (0.5755, 0.3447, 0.0585=0.9787). The fourth principal component Prin4 accounts for the remaining 2% of the variability (0.0213).

In this example, the first three principal components are selected for modeling, and the fourth principal component is discarded. This may be done for better determination of the correlation between the variables.

An AR(1) (first order autoregressive) model is fitted on the selected principal components (i.e. the first three principal components) in order to generate a spend forecast of automotive fuel for months 34 to 45. Table 3 shows the forecasted spending for the various months. For example, SAS software is used to fit the AR model to predict spends in automotive fuel using PROC ARIMA.

Table 4 shows the performance results of the model according to an exemplary implementation of the invention. The mean squared error for both in-sample and out-of-sample is 0.1% and 0.2% respectively, indicating that the model is performing satisfactorily.

Currently, in order to predict consumer spending, historical transaction data is aggregated and transformed into static variables to establish a linear distribution. A linear regression model is fitted on the static variables and the output of the linear regression model provides a prediction of consumer spending. One disadvantage of the current method is that linear regression models work on the assumption that all variables are independent of each other and follow no autocorrelation (i.e. no time-series behaviour), which in reality is not true. Another disadvantage is that linear regression models require a long rendering time for large datasets. A typical linear regression predictive model can take four to six weeks to develop and another eight to twelve weeks to implement.

Embodiments of the invention, as described above, provide improvements of the prior art. Firstly, embodiments of the invention retain the autocorrelation dependency between the variables (e.g. the selected one or more merchant categories). Secondly, embodiments of the invention seek to discard variables with weak correlation (i.e. variables with strong correlation are retained) in order to attain a reduced dataset before fitting the time-series model. Consequently, embodiments of the invention allow a reduction in model development time by about 40 to 50%.

Embodiments of the invention provide a computer-implemented method for prediction of consumer spending. The method comprises the following steps: identifying a correlation between the specific merchant category and two or more merchant categories, the two or more merchant categories different from the specific merchant category; selecting one or more merchant categories based on a degree of the correlation; fitting a time-series model to data of the selected one or more merchant categories; and predicting consumer spending in the specific merchant category using the output of the time-series model. Consumer spending predictions are commercially valuable. In particular, by using embodiments of the invention to predict consumer spending, merchants can advantageously plan revenue targets and business strategies to address changing or expected activities in markets. Accurate estimation of transaction or spend forecasts also helps in simulating various market and business scenarios to better manage risks. Inaccurate spend and revenue estimates can lead to wrong business plans and decisions with unrealistic revenue or cost targets, which in turn can lead to loss of customer and investor confidence.

Exemplary Computing Device

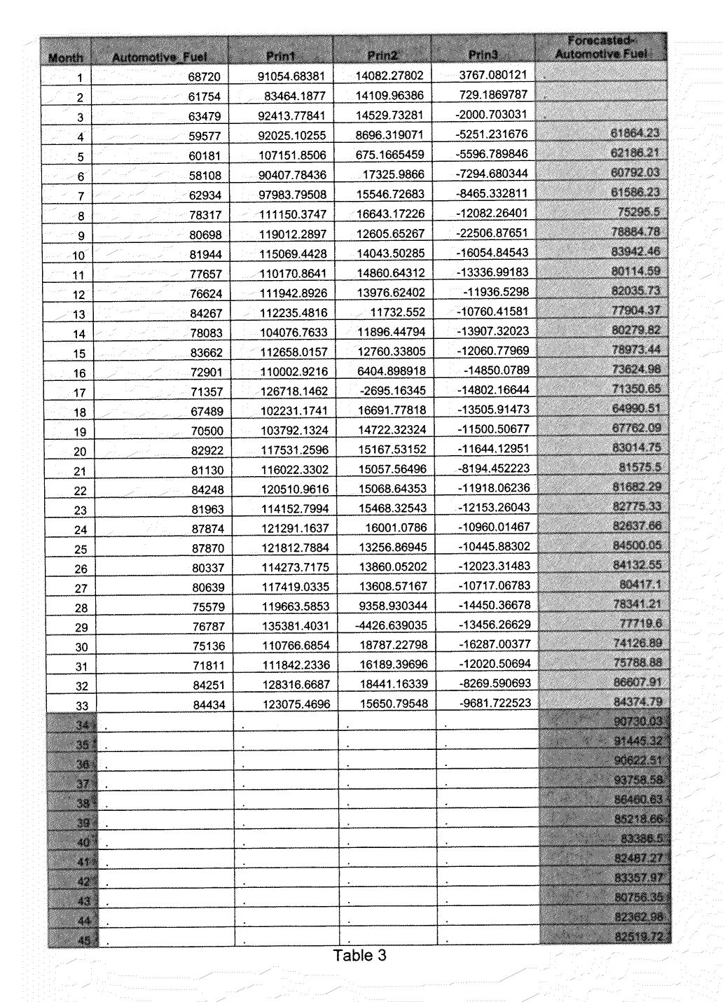

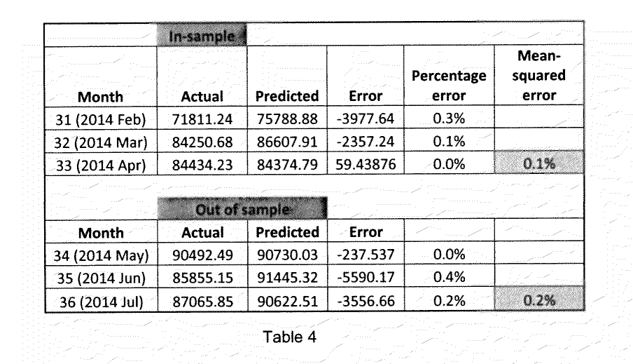

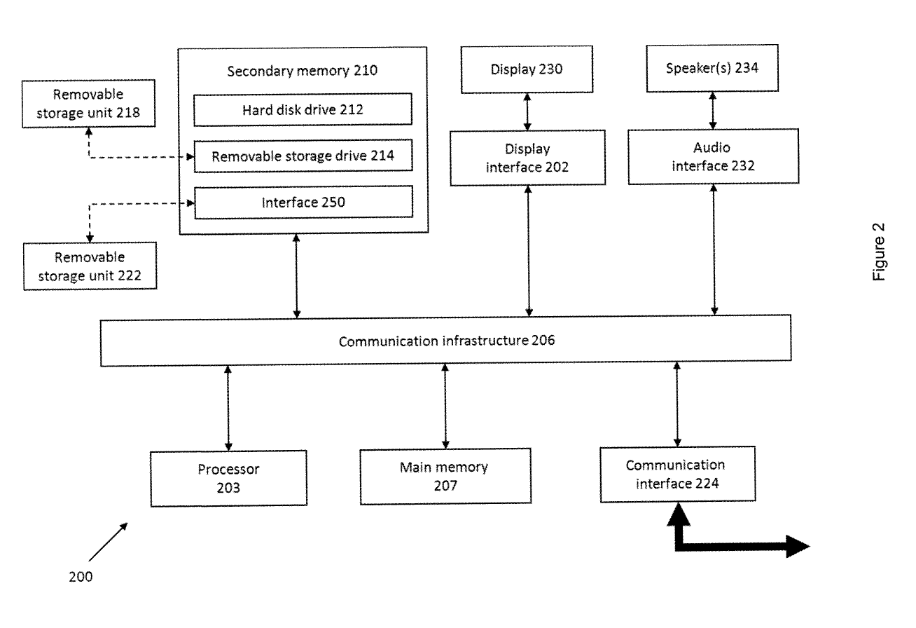

FIG. 2 shows an exemplary computing device/apparatus capable of executing the method for prediction of consumer spending according to various the implementations described herein. The following description of the computing device 200 is provided by way of example only and is not intended to be limiting. Therefore, one or more elements/components of the computing device 200 may be omitted. Also, one or more elements/components of the computing device 200 may be combined together. Additionally, one or more elements/components of the computing device 200 may be split into one or more component parts.

With reference to FIG. 2, the exemplary computing device 200 includes a processor 203 for executing software routines. Although a single processor is shown for the sake of clarity, the computing device 200 may also include a multi-processor system. The processor 203 is connected to a communication infrastructure 206 for communication with other components of the computing device 200. The communication infrastructure 206 may include, for example, a communications bus, cross-bar, or network.

The computing device 200 further includes a main memory 207, such as a random access memory (RAM), and a secondary memory 210. The secondary memory 210 may include, for example, a hard disk drive 212 and/or a removable storage drive 214, which may include a magnetic tape drive, an optical disk drive, or the like. The removable storage drive 214 reads from and/or writes to a removable storage unit 218 in a well-known manner. The removable storage unit 218 may include a magnetic disk, optical disk, or the like, which is read by and written to by removable storage drive 214. As will be appreciated by persons skilled in the relevant art(s), the removable storage unit 218 includes a computer readable storage medium having stored therein computer executable program code instructions and/or data.

In an alternative implementation, the secondary memory 210 may additionally or alternatively include other similar means for allowing computer programs or other instructions to be loaded into the computing device 200. Such means can include, for example, a removable storage unit 222 and an interface 250. Examples of a removable storage unit 222 and interface 250 include a program cartridge and cartridge interface, a removable memory chip (such as an EPROM or PROM) and associated socket, and other removable storage units 222 and interfaces 250 which allow software and data to be transferred from the removable storage unit 222 to the computing device 200.

The computing device 200 also includes at least one communication interface 224. The communication interface 224 allows software and data to be transferred between computing device 200 and external devices via a communication path 226. In various implementations, the communication interface 224 permits data to be transferred between the computing device 200 and a data communication network, such as a public data or private data communication network. The communication interface 224 may be used to exchange data between different computing devices 200 which such computing devices 200 form part an interconnected computer network. Examples of a communication interface 224 can include a modem, a network interface (such as an Ethernet card), a communication port, an antenna with associated circuitry and the like. The communication interface 224 may be wired or may be wireless. Software and data transferred via the communication interface 224 are in the form of signals which can be electronic, electromagnetic, optical or other signals capable of being received by communication interface 224. These signals are provided to the communication interface via the communication path 226.

As shown in FIG. 2, the computing device 200 further includes a display interface 202 which performs operations for rendering images to an associated display 230 and an audio interface 232 for performing operations for playing audio content via associated speaker(s) 234. For example, the display interface 202 is able to display the output of the time-series model, which comprises a prediction of future consumer spending.

As used herein, the term “computer program product” may refer, in part, to removable storage unit 218, removable storage unit 222, a hard disk installed in hard disk drive 212, or a carrier wave carrying software over communication path 226 (wireless link or cable) to communication interface 224. A computer readable medium can include magnetic media, optical media, or other recordable media, or media that transmits a carrier wave or other signal. These computer program products are devices for providing software to the computing device 200. Computer readable storage medium refers to any non-transitory tangible storage medium that provides recorded instructions and/or data to the computing device 200 for execution and/or processing. Examples of such storage media include floppy disks, magnetic tape, CD-ROM, DVD, Blu-ray Disc™, a hard disk drive, a ROM or integrated circuit. USB memory, a magneto-optical disk, or a computer readable card such as a PCMCIA card and the like, whether or not such devices are internal or external of the computing device 200. Examples of transitory or non-tangible computer readable transmission media that may also participate in the provision of software, application programs, instructions and/or data to the computing device 200 include radio or infra-red transmission channels as well as a network connection to another computer or networked device, and the Internet or Intranets including e-mail transmissions and information recorded on Websites and the like.

The computer programs (also called computer program code) are stored in main memory 207 and/or secondary memory 210. Computer programs can also be received via the communication interface 224. Such computer programs, when executed, enable the computing device 200 to perform one or more steps that facilitate the collection of indirect taxes. The computer programs, when executed, enable the processor 203 to facilitate the collection of indirect taxes. Accordingly, such computer programs may represent controllers of the computing device 200.

Software may be stored in a computer program product and loaded into the computing device 200 using the removable storage drive 214, the hard disk drive 212, or the interface 250. Alternatively, the computer program product may be downloaded to the computing device 200 over the communications path 226. The software, when executed by the processor 203, causes the computing device 200 to perform the necessary operations to execute one or more steps of the herein described method for prediction of consumer spending.

1. A computer-implemented method for prediction of consumer spending in a specific merchant category, the method comprising:
identifying a correlation between the specific merchant category and two or more merchant categories, the two or more merchant categories different from the specific merchant category;
selecting one or more merchant categories based on a degree of the correlation;
fitting data of the selected one or more merchant categories to a time-series model; and
predicting consumer spending in the specific merchant category using the output of the time-series model.

2. The method as claimed in claim 1, comprising using principal component analysis (PCA) to identify the correlation between the two or more merchant categories with the specific merchant category.

3. The method as claimed in claim 2, further comprising:
selecting two or more principal components; and
calculating an eigenvalue for each of the selected principal components to identify the correlation between the two or more merchant categories.

4. The method as claimed in claim 3, wherein the selected principal components account for a user determined degree of variance, upon which the correlation is based.

5. The method as claimed in claim 4, wherein predicting consumer spending in the specific merchant category using the output of the time-series model comprises comparing the output associated with the specific merchant category against the output associated with the selected one or more merchant categories to predict consumer spending in the specific merchant category.

6. The method as claimed in claim 1, wherein the time-series model is either an autoregressive (AR), autoregressive moving average (ARMA) or autoregressive integrated moving average (ARIMA) model.

7. The method as claimed in claim 1, wherein the data of each of the selected merchant categories comprise consumer spending in the corresponding selected merchant category.

8. The method as claimed in claim 7, wherein the data of each of the selected merchant categories are obtained based on historical transaction data.

9. The method as claimed in claim 8, wherein the historical transaction data comprises one or more of: merchant identity, transaction amount, date of transaction, merchant category code (MCC), industry code, and industry description.

10. An apparatus comprising:
at least one processor; and
at least one memory including computer program code, the at least one memory and the computer program code configured to, with the at least one processor, cause the apparatus at least to:
identify a correlation between the specific merchant category and two or more merchant categories, the two or more merchant categories different from the specific merchant category;
select one or more merchant categories based on a degree of the correlation;
fit data of the selected one or more merchant categories to a time-series model; and
predict consumer spending in the specific merchant category using the output of the time-series model.
